(19) United States
(12) Patent Application Publication
(10) Pub. No.: US 2014/0058913 A1
(43) Pub. Date: Feb. 27, 2014

(54) GRAPH PARTITIONING FOR DYNAMIC SECURITIZATION

(71) Applicants: Rex C. Hinesley, Raleigh, NC (US); James R. Kozloski, New Fairfield, CT (US); Brian M. O'Connell, Cary, NC (US); Clifford A. Pickover, Yorktown Heights, NY (US)

(72) Inventors: Rex C. Hinesley, Raleigh, NC (US); James R. Kozloski, New Fairfield, CT (US); Brian M. O'Connell, Cary, NC (US); Clifford A. Pickover, Yorktown Heights, NY (US)

(73) Assignee: INTERNATIONAL BUSINESS MACHINES CORPORATION, Armonk, NY (US)

(21) Appl. No.: 13/594,297

(22) Filed: Aug. 24, 2012

(51) Int. Cl. G06Q 40/00; G06T 11/20

(52) U.S. Cl. 705/35; 345/440

(57) ABSTRACT

Embodiments are directed to generating a graph comprising a plurality of nodes relevant to a securitization of a first of the nodes, the graph representing relationships from which the first node's value and risk are calculated, assigning a weight to each of relationships among the plurality of nodes, and generating a graph partition by retaining the nodes of the graph coupled to the first node that have a weight greater than a threshold.

### FIELD OF INVENTION

The present disclosure relates generally to graph partitioning, and more specifically, to a financial graph partitioning for dynamic securitization.

### DESCRIPTION OF RELATED ART

Securitization may be associated with a pooling and sale of debt to one or more investors. Principal and interest on the debt may be paid back to the investors. Securitization may extend beyond debt concerns. For example, musicians may securitize their future earnings on songs by selling bonds.

Typically, securitization of an asset or liability involves creating standard investment instruments from a pool of aggregated financial assets or liabilities, which are judged equivalent in some way, such that the resulting securities may be categorized and rated according to the underlying assets. For example, mortgages may be securitized and resold as investment instruments, known as securities. The resulting “mortgage-backed securities” are labeled based on the financial rating assigned to the underlying mortgages, which are intended to provide a quantifiable measure of the risk associated with the security.

### BRIEF SUMMARY

According to one or more embodiments of the present disclosure, a system for generating a graph partition comprises a computing device configured to generate a graph comprising a plurality of nodes relevant to a securitization of a first of the nodes, the graph representing relationships from which the first node's value and risk are calculated, assign a weight to each of relationships among the plurality of nodes, and generate a graph partition by retaining the nodes of the graph coupled to the first node by weights greater than a threshold.

According to one or more embodiments of the present disclosure, an apparatus for generating a graph partition comprises at least one processor, and memory having instructions stored thereon that, when executed by the at least one processor, cause the apparatus to generate a graph comprising a plurality of nodes relevant to a securitization of a first of the nodes, the graph representing relationships from which the first node's value and risk are calculated, assign a weight to each relationship among the plurality of nodes, and generate a graph partition by retaining the nodes of the graph related to the first of the nodes by a computed weight greater than a threshold.

According to one or more embodiments of the present disclosure, a method for generating a graph partition comprises generating, by a computing device, a graph comprising a plurality of nodes relevant to a securitization of a first of the nodes, the graph representing relationships from which the first node's value and risk are calculated, assigning, by the computing device, a weight to each of relationships among the plurality of nodes, and generating, by the computing device, a graph partition by retaining the nodes of the graph coupled to the first node that have a weight greater than a threshold.

According to one or more embodiments of the present disclosure, a non-transitory computer program product comprises a computer readable storage medium having computer readable program code stored thereon that, when executed by a computer, performs a method of generating a graph partition comprising generating a graph comprising a plurality of nodes relevant to a securitization of a first of the nodes, the graph representing relationships from which the first node's value and risk are calculated, assigning a weight to each of relationships among the plurality of nodes, and generating a graph partition by retaining the nodes of the graph coupled to the first node by weights greater than a threshold.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features and advantages of the disclosure are apparent from the following detailed description taken in conjunction with the accompanying drawings in which:

FIG. 1 is a schematic block diagram illustrating an exemplary computing system in accordance with one or more aspects of this disclosure.

FIG. 2 is a graph illustrating exemplary financial relationships in accordance with one or more aspects of this disclosure.

FIG. 3 is a partitioned graph illustrating exemplary financial relationships in accordance with one or more aspects of this disclosure.

FIG. 4 is a flow diagram illustrating an exemplary method in accordance with one or more aspects of this disclosure.

### DETAILED DESCRIPTION

In accordance with various aspects of the disclosure, assets may be measured based on their “relationships” to other assets, liabilities, and cash streams in a network (e.g., a financial network) using network analysis. Relationships that contribute most heavily to the measure may be preserved when applying a partition aggregation. Partitions may be created for one or more assets, preserving contributing relationships in the process. Partitions for one or more pooled assets may be preserved when the assets are securitized, and may be used to quantify a risk (e.g., a net risk) of the resulting security.

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this regard, a coupling of entities may refer to either a direct or an indirect connection.

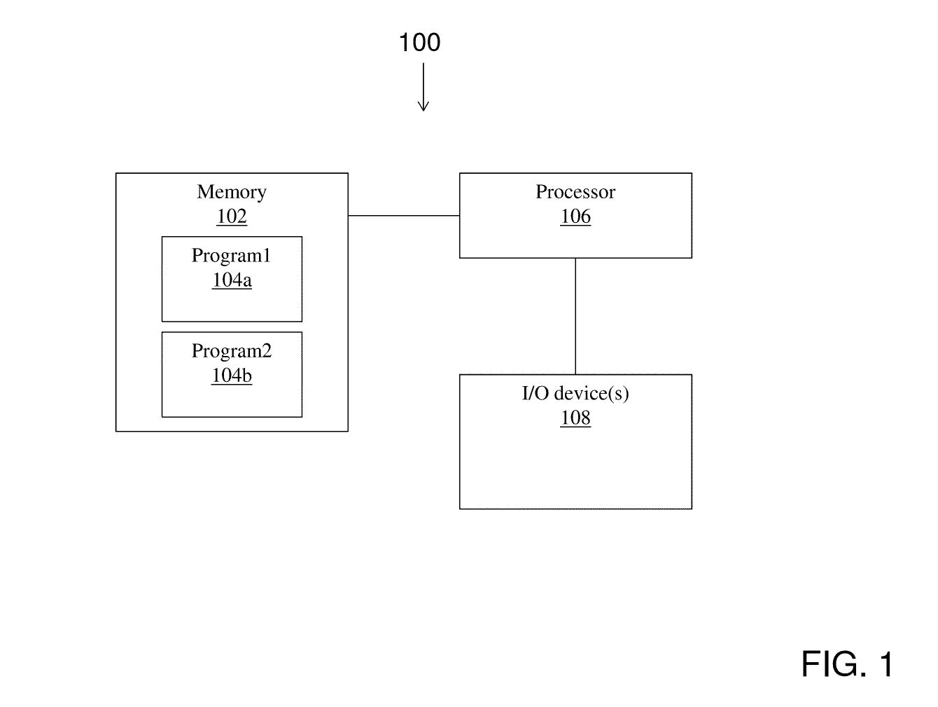

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more processes, routines, methods, etc. As an example, at least a portion of the instructions are shown in FIG. 1 as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard, a touchscreen, a display screen, a microphone, a speaker, a mouse, a button, a remote control, a joystick, a printer, etc. The I/O device(s) 108 may be configured to provide an interface to allow a user to interact with the system 100.

The system 100 is illustrative. In some embodiments, one or more of the entities may be optional. In some embodiments, additional entities not shown may be included. For example, in some embodiments the system 100 may be associated with one or more networks, which may be communicatively coupled to one another via one or more switches, routers, or the like. In some embodiments, the entities may be arranged or organized in a manner different from what is shown in FIG. 1. One or more of the entities shown in FIG. 1 may be associated with one or more of the devices or entities described herein.

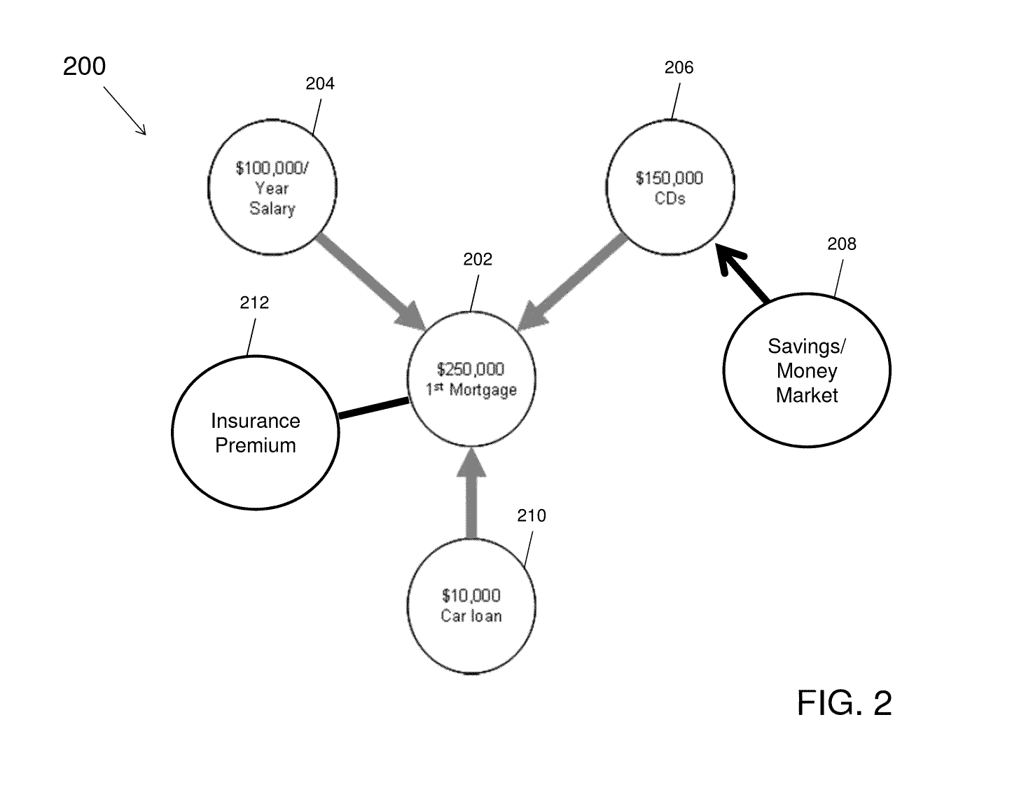

FIG. 2 illustrates a graph 200 that may be used to illustrate relationships between, e.g., a given set of financial assets, liabilities, and cash streams. For example, a mortgage 202 may be represented as a liability node in the graph 200. During origination of a loan, many factors may be considered to determine if a borrower will be able to repay the loan. These factors may themselves be representative of assets, liabilities, and cash streams. Accordingly, the factors may be represented as additional nodes in the graph 200.

In the graph 200, a salary 204, certificates of deposit (CDs) 206, savings/money market 208, a car loan 210, and an insurance premium 212 are represented as nodes contributing to the mortgage 202 by an edge coupling them to the mortgage 202. The salary 204, CDs 206, the car loan 210, and the insurance premium 212 may be referred to as first order nodes with respect to the mortgage 202 since they are directly coupled to the mortgage 202. The savings/money market 208 may be referred to as a second order node with respect to the mortgage 202 since the savings/money market 208 is separated from the mortgage 202 via an intervening node 206. In more complex graphs, nodes of three or even higher orders may be present.

The dependency of the nodes may be represented by a directed edge, which may indicate the direction of the dependency. For example, the salary 204, the CDs 206 and the car loan 210 are represented with arrow-heads pointing to the mortgage 202, which may indicate that the mortgage 202 is dependent on, or driven by, the salary 204, the CDs 206 and the car loan 210. Similarly, the CDs 206 may be dependent on, or driven by, an amount available in the savings/money market 208.

The dependency of nodes may be represented by a non-directed edge, which may merely indicate that a relationship between the nodes exists. For example, the insurance premium 212 might not be generated until after the mortgage is closed or generated, but the insurance premium 212 may have a bearing on the borrower's ability to pay-off the mortgage 202. As such, an arrow-head is not shown as being directed from the insurance premium 212 towards the mortgage 202 in FIG. 2, which may serve to indicate a non-directed edge between the mortgage 202 and the insurance premium 212.

In some embodiments, one or more weights may be assigned to, or associated with, one or more nodes. The weights may be indicative of the risk, impact, or influence that a node has another node or item to be securitized. The weights may be based on one or more scales or rating systems. As an illustrative example, a weight may be assigned a numerical value between zero and one.

Continuing the above example in connection with FIG. 2, the salary 204 may have a weight of 0.85. The CDs 206 may have a weight of 0.60. The savings/money market 208 may have a weight of 0.50. The car loan 210 may have a weight of 0.35. The insurance premium 212 may have a weight of 0.27.

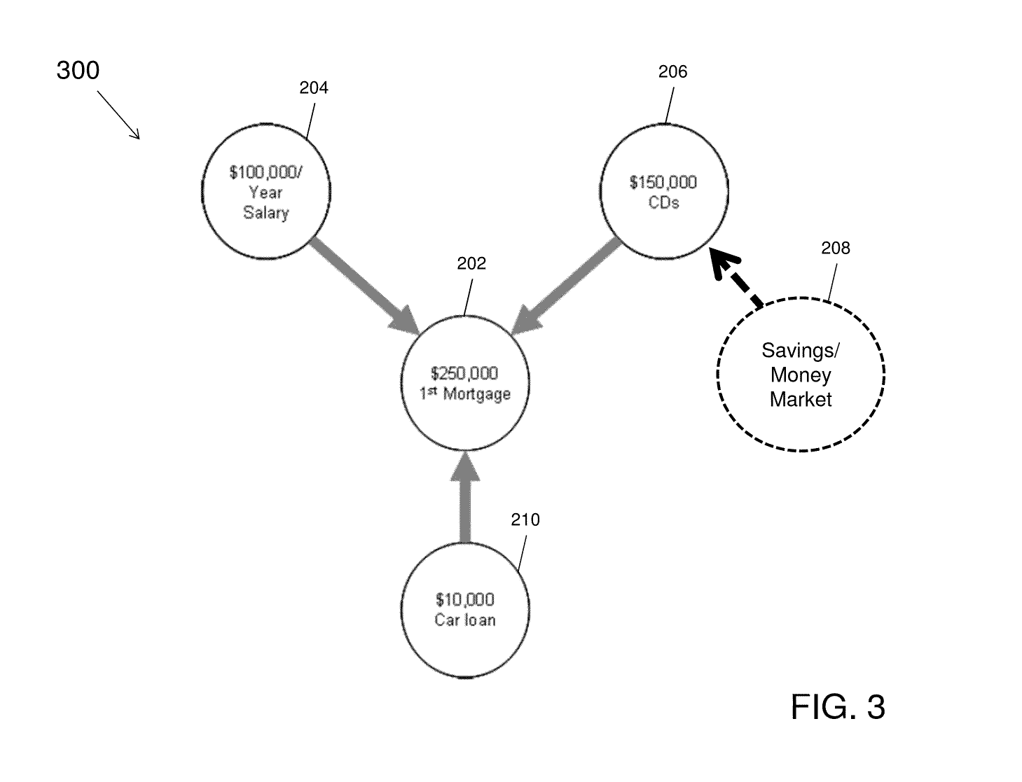

Based on the weights associated with the various nodes, computations or comparisons may be performed to partition a graph (e.g., the graph 200) to those node(s) that are likely to influence the node or item to be securitized (e.g., the mortgage 202) in an amount, or to a degree, greater than a threshold. For example, if a threshold is set at 0.31, the salary 204 (with a weight of 0.85), the CDs 206 (with a weight of 0.60), and the car loan 210 (with a weight of 0.35) exceed the threshold, and so they may be retained in a partitioned graph 300 of FIG. 3.

The insurance premium 212 (with a weight of 0.27) is less than the threshold of 0.31, and so it may be removed in transitioning from the graph 200 to the graph 300.

The savings/money market 208 may be included in the graph 300, as its weight (0.50) is greater than the threshold (0.31). However, a more sophisticated model may take into consideration that the savings/money market 208 is a second order node with respect to the mortgage 202. In this regard, the model may take the product of the weights of the CDs 206 and the savings/money market 208 to determine the likelihood or probability of the savings/money market 208 influencing the mortgage 202. Thus, taking the product of the weights of the CDs 206 and the savings/money market 208 yields 0.30 (e.g., 0.60×0.50=0.30), which is less than the threshold (0.31). As a result, the savings/money market 208 might not be included in the graph 300 in some embodiments.

The process described above regarding computations and comparisons between weights associated with nodes and one or more thresholds may continue for each branch of the graph until all the nodes in the branch have been considered, or until a (lower-order) node in the branch yields a value that is less than the threshold.

The examples described above are illustrative. Different graphs may be used in some embodiments, and the values provided are arbitrary.

A partitioned graph (e.g., graph 300) may be used to streamline a perspective associated with a larger or broader graph (e.g., graph 200), and may be used to provide focus to an analysis by removing or eliminating one or more nodes that have a minimal impact on a node under consideration.

A confidence level may be computed for a graph (e.g., the graph 200 and/or the graph 300). The confidence level may be based at least in part on the weights associated with the various nodes and may be indicative of an uncertainty associated with the weights assigned to the nodes. In some embodiments, when the confidence level is less than a threshold N, a signal (e.g., a voice message, an email, a text message, a report or document, etc.) may be generated that may indicate that additional analysis may be warranted. In some embodiments, the signal may be transmitted automatically.

The analysis associated with the signal may take the form of so-called “crowd-sourcing,” wherein one or more users or participants may be requested to provide a decision or judgment on the item or node of interest (in the examples above, the mortgage 202). In this regard, the signal may be provided to one or more experts, bulletin boards, a financial manager, etc.

In some embodiments, the signal may include a timing parameter that may specify a decision or judgment is required with X amount of time. In some embodiments, if such a decision/judgment is not provided in time, an action, such as a default action, may occur (e.g., proceed without such decision/judgment). The signal may include a specification of the action to be taken in the absence of a response (e.g., a decision or judgment) in time.

In some embodiments, an “active-learning” component may be used to enable a system to incorporate responses to a crowd-sourcing signal into an automatic assessment and analytic expert capability (including AIs). The responses may then be used to allow a subsequent assessment to proceed without a need for input (e.g., human input).

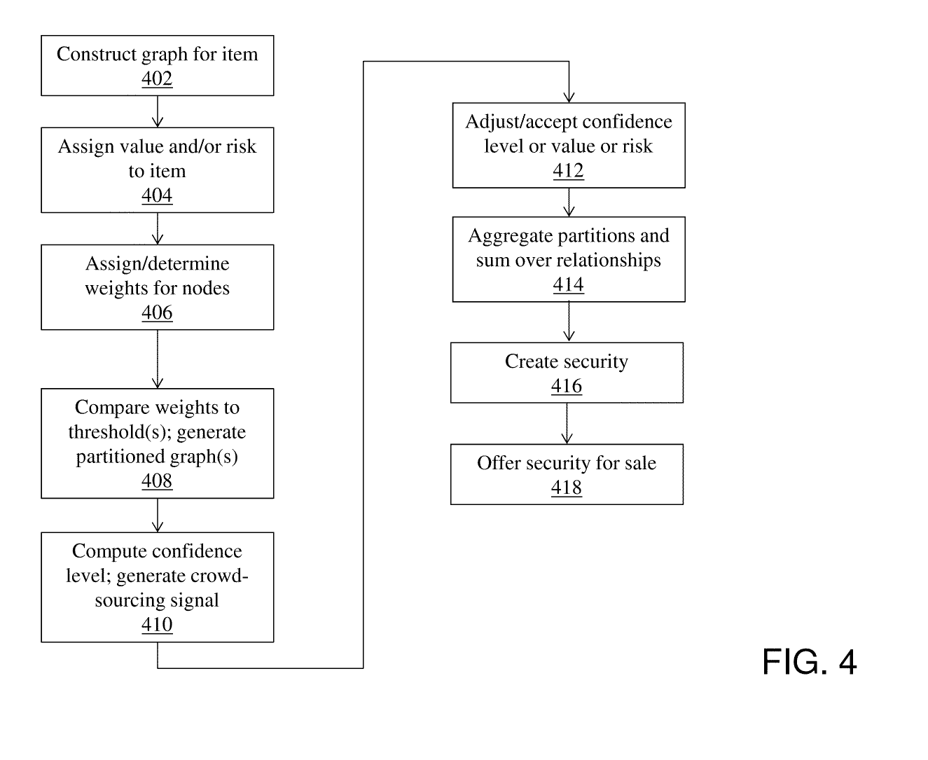

FIG. 4 illustrates a flow diagram of an exemplary method in accordance with one or more aspects of this disclosure. The method may be operative in connection with one or more systems or entities, such as those described herein. The method may be used to provide for a securitization of an item, such as an asset, a liability, a cash flow, etc.

In block 402, a graph (e.g., a financial graph), such as the graph 200, may be constructed for an item to be securitized. The graph may be constructed so as to represent relationships from which value and risk for the item may be derived or calculated. In some embodiments, a computing device or processor may be used to construct the graph.

In block 404, value and/or risk may be assigned to the item based on the graph and/or relationships associated with block 402.

In block 406, one or more weights may be assigned or determined for nodes of the graph.

In block 408, the weights of block 406 may be compared to one or more thresholds. As part of block 408, one or more partitioned graphs may be generated.

In block 410, a confidence level may be computed or generated for the graph of block 402 and/or the partitioned graph(s) of block 408. In some embodiments, the computation of the confidence level may be based on analytic and expert systems (including AIs). If the confidence level is less than a threshold, a request may be generated (e.g., automatically generated) to send or transmit a signal to request judgment information. The signal may correspond to a crowd-sourcing signal.

In block 412, the confidence level may be adjusted or accepted. For example, if a crowd-sourcing signal was transmitted in connection with block 410, a user may respond to the crowd-sourcing signal. The response may include a confirmation of one or more values and/or risks for the item in connection with block 404.

In block 414, all or a subset of graph partitions may be aggregated, and values and/or risk may be quantified or derived based on a summation over the relationships within the partitions.

In block 416, a security may be created based on the quantities associated with block 414.

In block 418, the created security of block 416, potentially along with one or more of the graph and the partition(s), may be sold or offered for sale. Investors may leverage the security, the graph, and/or the partition(s) to traverse relationships dynamically, and to re-evaluate risk and re-determine value.

It will be appreciated that the events of the method of FIG. 4 are illustrative in nature. In some embodiments, one or more of the operations or events (or a portion thereof) may be optional. In some embodiments, one or more additional operations not shown may be included. In some embodiments, the operations may execute in an order or sequence different from what is shown in FIG. 4.

Aspects of the disclosure may apply a firewall to information that may be available, such as in connection with one or more graphs or partitions. For example, some information may be declared as being sensitive, confidential, protected, etc. A firewall may be used to grant or deny access to information, potentially based on various criteria or permissions. Such criteria or permissions may be based at least in part on stock market conditions, time of day, key words being used in news stories, etc. A degree of control or access may be based on various classes of user. For example, a president of a company may have a greater degree of access to information than a vice president of the company.

In some embodiments, graph or partition linkages may be severed. For instance, the value of an asset could be evaluated in isolation from some risky node in a graph, as it may have been driven down in price by the collapse of the market for its underlying assets and a new price propagated ahead of a wave of defaults. Such features could be used to allow a party (e.g., an institution) to model or avert getting swept-up in a cascading default or spreading (financial) contagion.

Embodiments of the disclosure may enable macroeconomic factors to influence a risk assessment. For example, if a particular individual associated with the mortgage 202 worked in an industry or employment sector that is susceptible to large swings or variations in terms of unemployment, it may be possible to estimate future risk by measuring trends for industry specific stocks relating to the individual's employment. In this manner, increased visibility may be obtained regarding shifts or changes in a risk profile associated with the mortgage 202. Similarly, shifts in one or more interest rates associated with the CDs 206 could be monitored to determine an impact on the borrower's ability to pay the mortgage 202.

In some embodiments, a user (e.g., a purchaser) of a security associated with the mortgage 202 may establish one or more thresholds or flags in connection with a computing device (e.g., a server, a personal computer, a laptop computer, a mobile device, etc.), and the computing device may generate a message or warning when risk exceeds the threshold/flag. In this manner, a self-monitoring application or environment may be established, thereby alleviating a user (e.g., a purchaser) of a security associated with the mortgage 202 of the burden of having to actively monitor (a risk profile or value associated with) the mortgage 202.

In some embodiments various functions or acts may take place at a given location and/or in connection with the operation of one or more apparatuses or systems. In some embodiments, a portion of a given function or act may be performed at a first device or location, and the remainder of the function or act may be performed at one or more additional devices or locations.

As will be appreciated by one skilled in the art, aspects of this disclosure may be embodied as a system, method or computer program product. Accordingly, aspects of the present disclosure make take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosure may take the form of a computer program product embodied in one or more computer readable medium(s) having computer readable program code embodied thereon.

Any combination of one or more computer readable medium(s) may be utilized, such as one or more non-transitory computer readable mediums. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific example (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the disclosure may be tied to particular machines. For example, one or more computers may be used to sell or buy a security. The security may have a risk (e.g., a dynamic risk) associated with it, and the computer(s) may be used to provide an indication of that risk.

Embodiments of the disclosure may transform an article into a different state or thing. In contrast to prior methodologies that merely categorized, aggregated, and securitized assets, embodiments of the disclosure provide for assets to be measured based on their relationships to other assets, liabilities, and cash streams in a network. Accordingly, embodiments of the disclosure may provide for a real-time or near real-time risk perspective of an asset or security, potentially in view of dynamic conditions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There may be many variations to the diagram or the steps (or operations) described therein without departing from the spirit of the disclosure. For instance, the steps may be performed in a differing order or steps may be added, deleted or modified. All of these variations are considered a part of the disclosure.

It will be understood that those skilled in the art, both now and in the future, may make various improvements and enhancements which fall within the scope of the claims which follow.

1. A system for generating a graph partition, comprising:
a computing device configured to:
generate a graph comprising a plurality of nodes relevant to a securitization of a securitizable item represented by a first of the nodes in the graph, the graph representing relationships from which the securitizable item's value and risk are calculable,
assign a weight to each of the relationships among the plurality of nodes,
generate, by a computer processor, a graph partition by retaining in the graph the nodes of the graph coupled to the first node by weights greater than a threshold and by removing from the graph the nodes coupled to the first node by weights less than the threshold; and
provide a security by securitizing the securitizable item based at least in part on the graph.

2. The system of claim 1, wherein the weight associated with each node is a function of the order of the node with respect to the first node.

3. The system of claim 2, wherein the function comprises, for each node, a multiplication of the assigned weight of the first node's relationship to the node and the assigned weights of intervening relationships of nodes between the node and the first node.

4. The system of claim 1, wherein the computing device is configured to compute a confidence level associated with the graph.

5. The system of claim 4, wherein the computing device is configured to generate a crowd-sourcing signal when the confidence level is less than a threshold.

6. The system of claim 5, wherein the computing device is configured to receive a response to the crowd-sourcing signal.

7. The system of claim 6, wherein the response comprises at least one of an adjustment to and an acceptance of at least one of the confidence level, a calculated value of the securitizable item of the first node, and a calculated risk of the securitizable item of the first node.

8. The system of claim 1, wherein the computing devices comprise at least one of a server, a personal computer, a laptop computer, and a mobile device.

9. An apparatus for generating a graph partition, comprising:
at least one processor; and
memory having instructions stored thereon executable by the at least one processor, thereby causing the apparatus to:
generate a graph comprising a plurality of nodes relevant to a securitization of a securitizable item represented by a first of the nodes in the graph, the graph representing relationships from which the securitizable item's value and risk are calculable;
assign a weight to each relationship among the plurality of nodes;
generate a graph partition by retaining in the graph the nodes of the graph related to the first node by a computed weight greater than a threshold and by removing from the graph the nodes related to the first node by weights less than the threshold; and
provide a security by securitizing the securitizable item based at least in part on the graph.

10. The apparatus of claim 9, wherein the computed weight associated with each node is a function of the order of the node with respect to the first node.

11. The apparatus of claim 9, wherein the instructions, when executed by the at least one processor, cause the apparatus to:
generate a second graph partition by retaining in the graph the nodes related to the first node by weights greater than a second threshold.

12. The apparatus of claim 11, wherein the instructions, when executed by the at least one processor, cause the apparatus to:
aggregate the graph partition and the second graph partition, and
calculate the securitizable item's value and risk based on a function of relationships included in the aggregate.

13. The apparatus of claim 9, wherein the instructions, when executed by the at least one processor, cause the apparatus to:
compute a confidence level associated with the graph.

14. The apparatus of claim 13, wherein the instructions, when executed by the at least one processor, cause the apparatus to:
offer the security for sale.

15. The apparatus of claim 9, wherein the instructions, when executed by the at least one processor, cause the apparatus to:
re-calculate the securitizable item's value and risk based on a change in a condition associated with at least one of the nodes.

16. The apparatus of claim 9, wherein the instructions, when executed by the at least one processor, cause the apparatus to:
condition access to information associated with the graph based on at least one of a class of a user, a market condition, a time of day, and one or more key words used in at least one news story.
